(19) United States
(12) Patent Application Publication
(10) Pub. No.: US 2011/0047871 A1
(43) Pub. Date: Mar. 3, 2011

(54) Plant support and water displacement apparatus

(76) Inventor: James Patrick Bowerman, Savannah, GA (US)

(21) Appl. No.: 12/806,974

(22) Filed: Aug. 25, 2010

Related U.S. Application Data
(60) Provisional application No. 61/275,051, filed on Aug. 25, 2009.

(51) Int. Cl. A01G 9/12

(52) U.S. Cl. 47/44

(57) ABSTRACT

Disclosed is a plant support and water displacement apparatus, comprised of one or more segments of tubing, configurable to multiple lengths and shaped like a corkscrew with a hollow channel to transport liquids through the plant support system and displace liquids directly at the plants roots. Multiple water reservoirs may be employed to store and displace added liquids. Plant support and water displacement apparatus may also have a decorative feature with the addition of plastic shaped leaves to appear to as natural vegetation.

First submitted Aug, 25, 2009 with provisional application No. 61/275,051

### FIELD OF THE INVENTION

This disclosure relates generally to a plant support and water displacement apparatus particularly, to a plant support comprised of one or more adjoining tubes with a hollow channel used to disperse liquids, such as water, directly or indirectly through a connecting porous material channeling liquids to the root of the plant. Additional reservoirs may also be added to either end of the plant support tubing to provide containers for excess liquid storage and disbursement.

### BACKGROUND OF THE INVENTION

For centuries (if not longer) people have used various forms of material to support their plants and tomatoes. Some of the supports include wooden stakes, sticks, metal rods, or strings. Support material is necessary in order to keep plants and tomatoes off the ground while providing the proper room to grow and gather sunlight. Support materials also keep fruits and vegetables less vulnerable to bugs, by keeping them in an elevated position above the ground, preventing the rotting of ripe fruit that occurs when left touching the soil directly.

Since water is essential to the growth of plants and tomatoes it can be a common problem for even the experienced gardener to go on vacation and forget to water one's plants. Without water plants and vegetables can quickly burn out in the sun and become brown and wilted, resulting in the loss of any potential fruits or vegetables the plant would have yielded if properly watered.

One means of remedying such occurrences is to have a plant or tomato support that not only keeps plants off the ground, but provides them with water so that a plant or tomato could be self watering over a few days or numerous weeks. This way the plant or tomato owner could leave their garden unattended for an undetermined amount of time and come back to find his plants and tomatoes healthy and vivacious because they have been properly watered in the owners absence. This feature is particularly useful when one wishes to go on vacation and doesn't have anyone around to water their home garden, or for people that work late and don't have the time to keep up with watering their tomatoes.

### SUMMARY OF THE INVENTION

Disclosed is a plant support and water displacement apparatus for plants and vegetables, particularly tomatoes, including one or more segments of tubing configured to form a corkscrew like design to the users desired length. Additional reservoirs for liquids, particularly water, may be added to either end of the support tubing to provide the user with the desired amount of water for their home gardens. Liquid can be added to one end of the plant support tubing while being dispersed by the other end placed under the ground close to the plants roots for optimum growth potential. The end placed in the ground by the plants roots may but not necessary have connecting porous material to help regulate the flow of liquid as it is disbursed throughout the roots of the plant.

### BRIEF DESCRIPTION OF THE FIGURES

The following descriptions should not be considered limiting in any way. With reference to the accompanying drawings, like elements are numbered alike. A preferred embodiment of the invention is seen in the attached drawings, in which:

FIG. 1 is a side view of the plant support and water displacement apparatus.

FIG. 2 is a side view of a plant support and water displacement apparatus with connecting liquid reservoirs.

FIG. 3 is a three quarters perspective of a water displacement apparatus with connecting liquid reservoirs, connective support tubing, and decorative leaf display.

### DETAILED DESCRIPTION

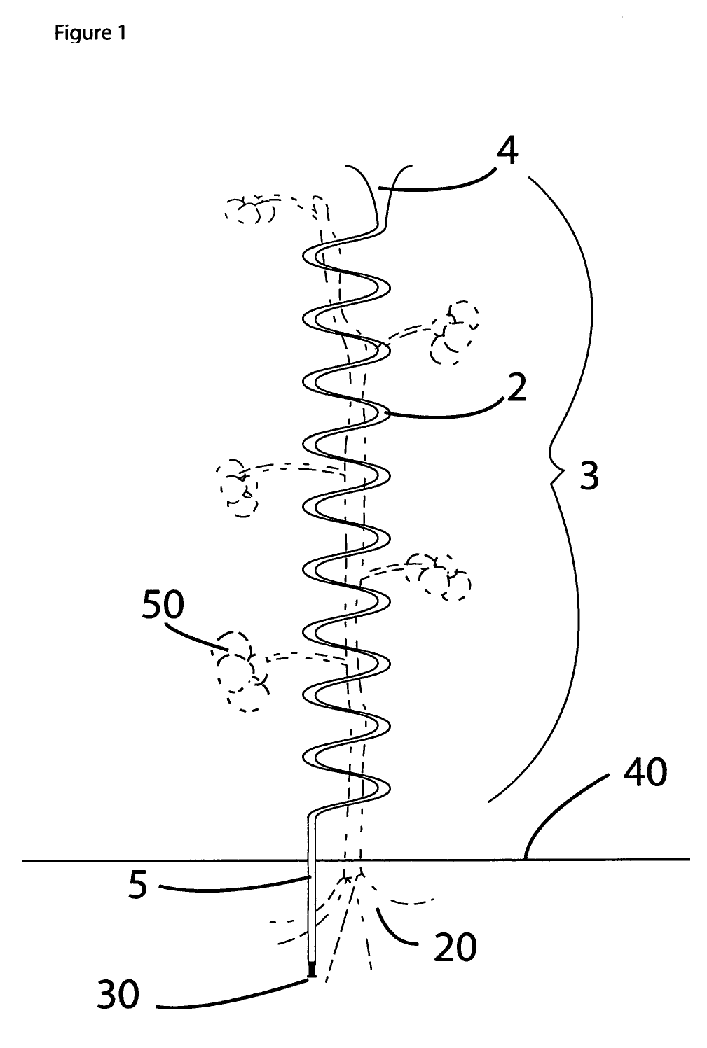

Referring now to FIG. 1, a first preferred embodiment of the plant support and water displacement apparatus includes an elongated shaped body 3 which can be made of tubing included but not limited to acrylic, plastic, pvc, metal, copper, glass, or any other known tubing material useful for plant support. Elongated shaped body 3 has a hollow center and consists of two separate ends, the north end 4, may have a wider opening allowing the user to pour water into the hollow tubing of elongated shaped body 3. The corkscrew design of the elongated shaped body 3 supports the plants branches and fruit 50, while holding water throughout its interior channel 2. The south end 5 of elongated shaped body 3 has an opening that can be placed next to the roots of the plant 20, beneath the soil 40, so that water may be added in northern end 4, housed inside the interior channel 2 of elongated body 3 and slowly dispersed through southern opening 5.

It should be appreciated in regards to southern opening 5, that a cork, cap, or clay attachment 30, may be attached to opening 5 on elongated body 3, to regulate the flow of liquids being transported through channel 2. Attachment 30 may be made up of any porous material including but not limited to cork, plastic, rubber, wood, fertilizer, clay or any other known material used in the displacement of liquid.

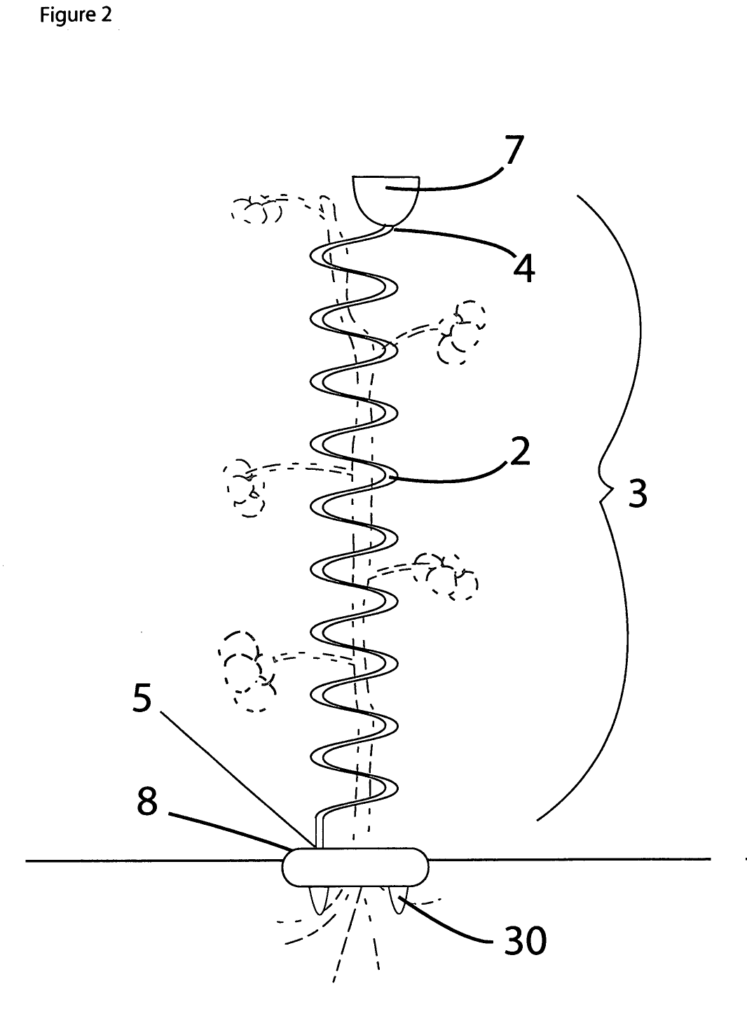

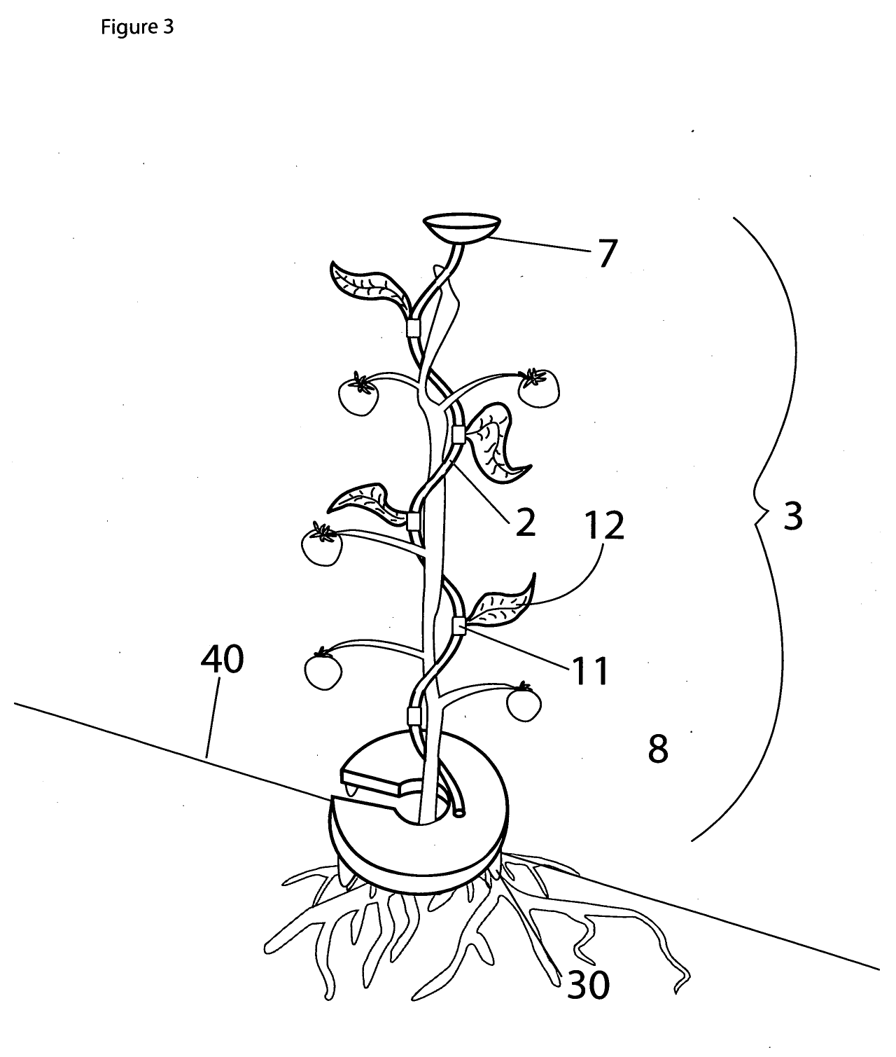

It should be appreciated that in regards to elongated body 3, additional liquid reservoirs may be attached to either ends of elongated body 3, in order to store additional liquids being transported through channel 2, a large dish or bowl shaped material 7, may be attached to opening 4. Along with liquid container 8 attached to opening 5, as shown in both FIGS. 2 and 3. Bowl shaped material 7, and liquid container 8 may be made up of but not limited to clay, plastic, glass or any known material adequate in the containment liquids.

In regards to liquid container 8, as shown in FIGS. 2 and 3, attachment 30 may be connected to liquid container 8 to aid in the displacement of water and stabilize liquid container 8 as it may be placed halfway or fully in the soil.

Referring now to FIG. 3, a three quarters view of a plant support and water displacement apparatus is shown, with segments of tubing being connected by Connectors 11 to make up the entirety of elongated body 3, and its corkscrew design. Connectors 11 may be larger pieces of tubing that allow a firm connection between smaller segments of tubing. It should be appreciated that in regards to elongated body 3, that the specific length between coils may vary. Decorative leaves 12 may be attached to connectors 11 or any where along elongated body 3 to give elongated body 3 the appearance of looking like an actual plant. Decorate leaves 12 may be made up of any known material including but not limited to plastic or paper. Decorate leaves 12 may be attached through any known connective means including but not limited to Velcro, glue, or a plurality of straps.

It should also be appreciated that while elongated body 3 is shown in FIGS. 1, 2, and 3 as a corkscrew design, variation in form may occur to elongated body 3 without departing from the scope of this invention.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated, any use of the terms first, second, etc. do not denote any order or importance, but rather the terms first, second, etc. are used to distinguish one element from another.

What is claimed is:

1. A plant support and water displacement apparatus, comprising:
a tube or series of connecting tubes used to form a support for plants and tomatoes;
a corkscrew design containing a hollow channel used to transport liquids from one opening to another;
additional liquid reservoirs connected at either end of the plant support;
porous materials connected at either opening to regulate the flow of liquids from the plant support to the soil.

2. The space between coils on said plant support system may vary in length.

3. Plant support and water displacement apparatus may contain additional decorative elements to mimic nature.
